(19) United States
(12) Patent Application Publication
(10) Pub. No.: US 2006/0033777 A1
(43) Pub. Date: Feb. 16, 2006

(54) Liquid ejection head and liquid ejection apparatus

(76) Inventors: Toshio Fukuda, Kanagawa (JP); Naoshi Ando, Kanagawa (JP); Masayuki Takakura, Kanagawa (JP); Iwao Ushinohama, Kanagawa (JP)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 11/198,501

(22) Filed: Aug. 5, 2005

(30) Foreign Application Priority Data
Aug. 11, 2004 (JP) P2004-234747

(51) Int. Cl. B41J 2/05

(52) U.S. Cl. 347/58

(57) ABSTRACT

A liquid ejection head mounted in a liquid ejection apparatus for ejecting liquid includes a first substrate including a pressure generating element for applying pressure to the liquid, a second substrate including a control circuit for controlling the drive of the pressure generating element, an external wiring member for electrically connecting the first substrate to the second substrate, a nozzle sheet having a nozzle for ejecting the liquid and a window portion through which a connection portion between the external wiring member and the first substrate is exposed to the outside. The window portion is sealed with a resin material and a seal portion formed from the resin material is cured so as to have a Shore D hardness of more than or equal to 55.

### CROSS REFERENCES TO RELATED APPLICATIONS

The present invention contains subject matter related to Japanese Patent Application JP 2004-234747 filed in the Japanese Patent Office on Aug. 11, 2004, the entire contents of which are incorporated herein by reference.

### BACKGROUND OF THE INVENTION

1. Field of the Invention

The present invention relates to a liquid ejection head in which a first substrate having a pressure generating element is electrically connected to a second substrate having a driving circuit for driving the pressure generating element via an external wiring member and relates to a liquid ejection apparatus including the liquid ejection head.

2. Description of the Related Art

Inkjet printing apparatuses print characters and images on recording paper by heating ink to form a bubble, which increases the volume of the ink and ejects ink drops onto the recording paper. Such printing apparatuses provide significantly low-noise printing and high-speed recording without an extra process to fix the ink on plain paper. In the printing apparatuses, an ink ejection head for ejecting ink includes an ink chamber in which ink is filled, a circuit board disposed in the ink chamber and having a pressure generating element, such as a heat element or a piezo-electric element for applying pressure to the ink, and a nozzle for ejecting the ink.

For example, Japanese Examined Patent Application Publication No. 6-4325 discloses an ink ejection head including a circuit board 200 shown in FIG. 7. The circuit board 200 includes a pressure generating element 202, such as an electrothermal transducer or a piezoelectric element, and a wire 203 electrically connected to the pressure generating element 202. In the circuit board 200, a driving circuit for controlling the drive of the circuit board 200 is connected to the wire 203 via a flexible printed circuit board 204 so as to control the drive of the pressure generating element 202. A protective film 205 is formed on the pressure generating element 202 for protecting the pressure generating element 202 against ink.

As shown in FIG. 7, in the circuit board 200, since a plurality of the pressure generating elements 202 are arranged along a short side of a substrate 201, the interconnection area of the wires 203 connected to the pressure generating elements 202 increases in size, thus expanding the substrate 201. Accordingly, as the circuit board 200 increases in size, the ink ejection head also increases in size. Additionally, in the circuit board 200, the substrate 201 is composed of an expensive material, such as silicon (Si). Therefore, the cost of the circuit board 200 rises with the increase in size.

Furthermore, in the circuit board 200, to electrically connect to the wires 203, the flexible printed circuit board 204 extends to the wires 203 and terminals of the flexible printed circuit board 204 are connected to the wires 203 by pressure bonding, wire bonding, soldering, or thermocompression bonding. In the circuit board 200, for example, a pattern of the pressure generating elements 202 and a pattern of the wires 203 connected to the pressure generating elements 202 change depending on products, such as printing apparatuses for calculators and facsimiles. For example, a pattern for a printing apparatus for a calculator has 8 wires with a spacing of 2.5 wires/mm whereas a pattern for a printing apparatus for a facsimile has 16 wires with a spacing of 4 wires/mm.

In the circuit board 200, different masks are used for different products, such as printing apparatuses for calculators and facsimiles in an etching process and a sputter-deposition process. Thus, the etching process and the sputter-deposition process become complicated and the manufacturing yield of the product decreases. In addition, in this circuit board 200, a small spacing between the arranged wires 203 makes the etching process and the sputter-deposition process to be further complicated. Accordingly, a short circuit between the wires 203 tends to occur.

To solve these problems, an ink ejection head 300 shown in FIG. 8 has been proposed. In the ink ejection head 300, a few pressure generating elements 302 are arranged on a circuit board 301 and a plurality of the circuit boards 301 are arranged. In the ink ejection head 300, the circuit board 301 includes a wire 303 electrically connected to each pressure generating element 302. A drive control unit 304 includes a control circuit for controlling the pressure generating elements 302, an electrode portion 305, and an external wiring member 306 for electrically connecting the wire 303 to the electrode portion 305. In the ink ejection head 300, the external wiring member 306 is disposed near a nozzle sheet 307 in which an ejection port 307a for ejecting ink is formed. The external wiring member 306 extends beyond the level of an ejection surface 307b. Accordingly, in order to protect the external wiring member 306 and in order to increase the reliability of the connection between the external wiring member 306 and the wire 303 and between the external wiring member 306 and the electrode portion 305, the ink ejection head 300 includes a seal portion 308 which seals the whole external wiring member 306 and connection points between the external wiring member 306 and the wire 303 and between the external wiring member 306 and the electrode portion 305. Since the seal portion 308 is formed such that it covers the whole external wiring member 306 by externally injecting the resin material, the seal portion 308 extends beyond the level of the ejection surface 307b. Therefore, when the ejection surface 307b is cleaned by a cleaning roller for removing extra ink, the cleaning roller is brought into contact with the seal portion 308 protruding from the level of the ejection surface 307b. If the cleaning roller is brought into contact with the seal portion 308, a pressure is applied to the external wiring member 306 via the seal portion 308. To prevent the pressure applied to the external wiring member 306, it is desirable that the seal portion 308 has some degree of hardness. If the hardness of the seal portion 308 is low, the external wiring member 306 swings while following the motion of the cleaning roller when the pressure is applied from the cleaning roller to the external wiring member 306. Thus, the external wiring member 306 may come apart from its contact with the wire 303 and the electrode portion 305. If the pressure generating element 302 is electrically disconnected from the drive control unit 304, the ink ejection head 300 becomes inoperable. In contrast, if a pressure applied to the ejection surface 307b is decreased to reduce the pressure applied to the seal portion 308, the external wiring member 306 can be prevented from coming apart from the connection points. However, the cleaning performance of the cleaning roller for cleaning the ejection surface 307b decreases.

### SUMMARY OF THE INVENTION

According to an embodiment of the present invention, there are provided a liquid ejection head and a liquid ejection apparatus having the liquid ejection head that includes a first substrate including a pressure generating element, a second substrate including a control circuit for controlling the drive of the pressure generating element, and an external wiring member for electrically connecting the first substrate to the second substrate, and that increases the reliability of a connection portion between the external wiring member and the first substrate by sealing the connection portion with a resin material having a hardness higher than that of a known liquid ejection head.

According to an embodiment of the present invention, a liquid ejection head mounted in a liquid ejection apparatus for ejecting liquid includes a first substrate including a pressure generating element for applying pressure to the liquid, a second substrate including a control circuit for controlling the drive of the pressure generating element, an external wiring member for electrically connecting the first substrate to the second substrate, and a nozzle sheet having a nozzle for ejecting the liquid and a window portion through which a connection portion between the external wiring member and the first substrate is exposed to the outside, wherein the window portion is sealed with a resin material and a seal portion formed from the resin material is cured so as to have a Shore D hardness of more than or equal to 55.

According to an embodiment of the present invention, a liquid ejection apparatus for performing a recording operation by ejecting liquid onto an object includes an apparatus body and a liquid ejection head mounted in the apparatus body. The liquid ejection head includes a first substrate including a pressure generating element for applying pressure to the liquid, a second substrate including a control circuit for controlling the drive of the pressure generating element, an external wiring member for electrically connecting the first substrate to the second substrate, and a nozzle sheet having a nozzle for ejecting the liquid and a window portion through which a connection portion between the external wiring member and the first substrate is exposed to the outside, wherein the window portion is sealed with a resin material and a seal portion formed from the resin material is cured so as to have a Shore D hardness of more than or equal to 55.

According to the above-described embodiments of the present invention, the external wiring member connects the first substrate including a pressure generating element to the second substrate including a control circuit for controlling the pressure generating element. By sealing the connection portion between the external wiring member and the first substrate with a resin material having a Shore D hardness of more than or equal to 55, the deformation of the seal portion can be prevented even when an external pressure is applied to the seal portion. Thus, according to the embodiments of the present invention, even when an external pressure is applied to the seal portion, the pressure is not transferred to the connection portion between the external wiring member and the first substrate inside the seal portion. Consequently, the external wiring member can be prevented from breaking or coming apart from the wiring and the control circuit.

### BRIEF DESCRIPTION OF THE DRAWINGS

FIG. 1 is an exploded perspective view of a printing apparatus according to an embodiment of the present invention;

FIG. 2 is an exploded perspective view of a liquid ejection cartridge;

FIG. 3 is a sectional view of the liquid ejection cartridge;

FIG. 4A is a schematic sectional view of a liquid ejection head when a bubble is generated on a heating element;

FIG. 4B is a schematic sectional view of the liquid ejection head when ink is ejected from a nozzle;

FIG. 5 is a schematic diagram of the liquid ejection cartridge when an ejection surface is cleaned while an ejection-surface protective cover is moving frontward;

FIG. 6 is a side perspective view of the printing apparatus for illustrating the printing operation of the printing apparatus;

FIG. 7 is a plan view of a known circuit board; and

FIG. 8 is a sectional view of a known liquid ejection head.

### DESCRIPTION OF THE PREFERRED EMBODIMENTS

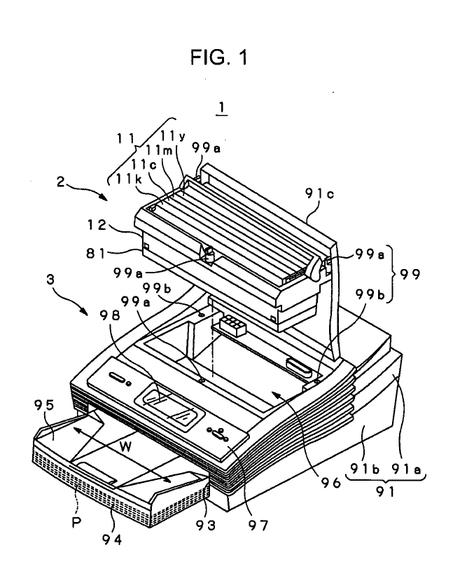

A printing apparatus according to an embodiment of the present invention is described in detail below with reference to the accompanying drawings. A printing apparatus 1 shown in FIG. 1 is a line printing apparatus in which ink ejection ports (nozzles) are arranged substantially in a straight line along the width direction of a recording paper sheet P, namely, in the direction shown by arrow W in FIG. 1. The ink ejection ports eject ink i onto the recording paper sheet P to record images and characters consisting of ink dots based on character data and image data.

The printing apparatus 1 includes a head cartridge 2, which is a liquid ejection head, and a printer body 3. The printer body 3 is a body of the printing apparatus 1 to which the head cartridge 2 is mounted. For the printing apparatus 1, the head cartridge 2 is considered to be a consumable supply. That is, the head cartridge 2 is removable from the printer body 3 so that a user can easily replace the head cartridge 2 with a new one.

The head cartridge 2 is described next. The head cartridge 2 is a line printer head in which a plurality of nozzles, which are ejection ports for ejecting the ink i, are arranged substantially in a straight line along the width of the recording paper sheet P.

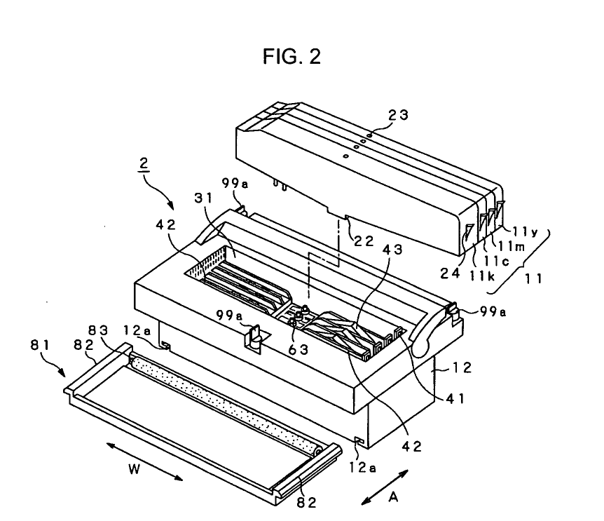

As shown in FIGS. 1 and 2, the head cartridge 2 includes a cartridge body 12 in which an ink tank 11 containing the ink i is mounted. To carry out color printing, the cartridge body 12 removably includes color ink tanks lly, 11m, 11c, and 11k (hereinafter collectively referred to as an ink tank 11) for four colors: yellow, magenta, cyan, and black. The ink i in the ink tank 11 contains a coloring agent, for example, a water-soluble dye serving as color dye or a variety of pigments, a solvent for dispersing the coloring agent, and a surface-active agent. For example, the ink i of yellow, magenta, cyan, and black colors are contained in the ink tanks 11y, 11m, 11c, and 11k, respectively.

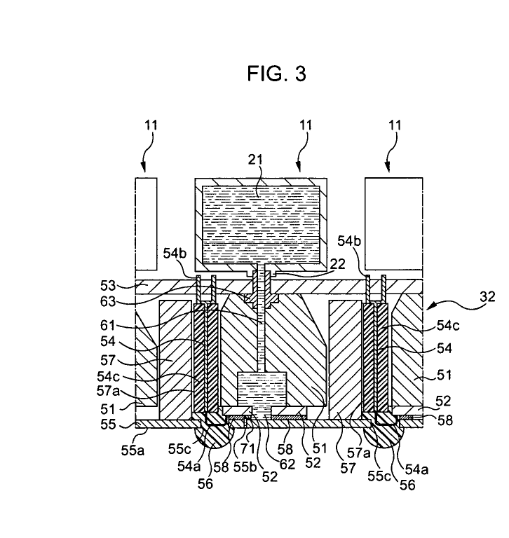

As shown in FIGS. 2 and 3, the ink tank 11 includes an ink container 21, which is a liquid container for containing ink i, and an ink discharger 22 for outputting the ink i in the ink container 21 to the cartridge body 12.

The ink container 21 provides a containing space for containing the ink i inside the ink tank 11. The ink discharger 22 extends downward from substantially the center of the bottom surface of the ink container 21. An air communicating hole 23 is formed at the center of the top surface of the ink container 21 to draw outside air. The ink container 21 can draw air via an intake pipe (not shown) extending inwards from the communicating hole 23. The ink tank 11 having such a structure is secured to a tank mounting portion 31 of the cartridge body 12 by a fixing member 24 formed at one end in the length direction of the ink tank 11. The tank mounting portion 31 is described later. Thus, the ink tank 11 is mounted on the cartridge body 12.

As shown in FIGS. 2 and 3, the cartridge body 12 in which the ink tank 11 is mounted includes the tank mounting portion 31 to which the ink tanks 11y, 11m, 11c, and 11k are mounted and an ejection unit 32 for ejecting the ink i.

As shown in FIG. 2, the tank mounting portion 31 of the cartridge body 12 is a recess having the shape of a substantially rectangle parallelepiped having a width of the recording paper sheet P and a depth sufficient to contain the ink tank 11. A catching part 41 is formed on the inner surface of the tank mounting portion 31. The catching part 41 is engaged with the fixing member 24. To mount the ink tank 11 in the tank mounting portion 31, the fixing member 24 of the ink tank 11 is engaged with the catching part 41 of the tank mounting portion 31.

A plurality of partition walls 42 are formed on the bottom surface of the tank mounting portion 31 in the direction of a short side of the bottom surface to determine the position of each ink tank 11. A resilient member 43 is attached between the partition walls 42. The resilient member 43 provides an elastic force in the direction to remove the ink tank 11 so as to push the ink tank 11 when the ink tank 11 is removed.

As shown in FIG. 3, the ejection unit 32 includes a passage plate 51 for defining a flow path of the ink i from the ink tank 11 to an ejection surface 55a, a first substrate 52 attached to the surface of the passage plate 51 adjacent to the ejection surface 55a, a second substrate 53 electrically connected to the first substrate 52, an external wiring member 54 for connecting the first substrate 52 to the second substrate 53, and a nozzle sheet 55 having a nozzle 55b for ejecting the ink i. Additionally, the ejection unit 32 includes a frame 57 having an opening 57a for each color to determine the positions of the passage plate 51, the first substrate 52, the second substrate 53, and the nozzle sheet 55. To assemble the ejection unit 32, the nozzle sheet 55 is bonded to the frame 57. The passage plate 51, the first substrate 52, and the second substrate 53 are then inserted into the opening 57a of the frame 57.

The passage plate 51 is formed from a material having rigidity not to easily deform and having the ink resistance to the contained ink i. The passage plate 51 is formed substantially as a line extending along the width of the recording paper sheet P so as to supply the nozzle 55b for each color with the ink i, since a plurality of the nozzles 55b are arranged along the line. The passage plate 51 includes a flow channel 61 which leads the ink i supplied from the ink tank 11 towards the ejection surface 55a and an ink liquid chamber 62 for holding the ink i at a position facing the first substrate 52.

The flow channel 61 includes a valve mechanism (not shown), which is opened by negative pressure occurring in a space from which the ink i is ejected and occurring when the ink i is ejected so as to deliver the ink i from the ink container 21 of the ink tank 11 to the ejection surface 55a. After the ink i is delivered from the ink container 21 of the ink tank 11 to the ejection surface 55a and the pressure in the ejection unit 32 returns to a normal pressure, the valve mechanism closes so as to stop supplying the ink i from the ink container 21 to the ejection unit 32.

The ink liquid chamber 62 connected to the flow channel 61 is formed along the width of the recording paper sheet P to define a pressuring space for applying pressure to the ink i. In the passage plate 51, a connection part 63 is formed on the flow channel 61 adjacent to the ink tank 11. The connection part 63 fits the ink discharger 22 of the ink tank 11 so that the ink i can be supplied from the ink tank 11.

The first substrate 52 is disposed on the passage plate 51 adjacent to the ink liquid chamber 62. A heat element 71 and a wire (not shown) for supplying a driving current and a control current to the heat element 71 are mounted on a surface of the first substrate 52 adjacent to the ejection surface 55a. The first substrate 52 is composed of, for example, glass, silicon, or ceramic.

The heat element 71 generates heat by a control circuit on the second substrate 53 controlling the supply of an electrical current. The control circuit is described later. The heat element 71 generates heat to heat the ink i in the ink liquid chamber 62, thereby generating an air bubble. The generated bubble applies pressure to the ink i in the ink liquid chamber 62 so as to eject a liquid droplet of the ink i from the nozzle 55b.

The wire is formed with a metal, such as aluminum, tantalum, titanium, magnesium, hafnium, zircon, vanadium, tungsten, molybdenum, and niobium, by, for example, vapor deposition. A connection portion is formed on the wire for connecting to the external wiring member 54, which is described below. The connection portion is formed with gold, silver-platinum alloy, or silver-palladium alloy by, for example, plating, screen printing, or vapor deposition. Additionally, a protective film may be formed over the wire to protect it.

In the second substrate 53, a control circuit and a wiring section connected to the first substrate 52 are formed on a semiconductor wafer made from, for example, silicon. The control circuit supplies the first substrate 52 with a control signal which is output from a control unit (not shown) of the printing apparatus 1 to control the drive of the heat element 71.

The external wiring member 54 connects the first substrate 52 to the second substrate 53. One end 54a of the external wiring member 54 is connected to a connection portion of the wire on the first substrate 52. The other end 54b of the external wiring member 54 is connected to, for example, a connection portion of a circuit pattern on the second substrate 53 so that the first substrate 52 is electrically connected to the second substrate 53. The external wiring member 54 passes through a resin layer 54c formed from an insulating resin. The ends 54a and 54b of the external wiring member 54, which are respectively connected to the first substrate 52 and the second substrate 53, are not covered by the resin layer 54c so as to be exposed to the outside.

The external wiring member 54 is formed from, for example, a gold wire, an aluminum wire, or an aluminum-silicon wire. The end 54a of the external wiring member 54 is curved towards the ejection surface 55a and is connected to the first substrate 52.

The nozzle sheet 55 is formed with a material consisting primarily of nickel by electrolytic plating. In the case of the head cartridge 2, since the nozzle 55b is a line type, that is, since a plurality of the nozzles 55b are arranged along the width direction of the recording paper sheet P, the nozzle sheet 55 is about 50×240 mm in dimension and about 13 μm in thickness. The nozzle 55b is formed in the nozzle sheet 55. The diameter of the nozzle 55b gradually reduces towards the ejection surface 55a. The diameter on the ejection surface 55a is about 20 μm. The nozzle sheet 55 faces the passage plate 51 and the first substrate 52 with a film 58 therebetween. The film 58 is a part of the wall surface of the ink liquid chamber 62.

A window portion 55c is formed in the nozzle sheet 55 such that the end 54a of the external wiring member 54 can be viewed through the window portion 55c. The window portion 55c serves as an injection port of a resin material when the window portion 55c is sealed. By sealing the window portion 55c with the resin material, a seal portion 56 is formed. The seal portion 56 protects a connection point between the end 54a of the external wiring member 54 and the connection portion of the wire on the first substrate 52. To completely cover the end 54a of the external wiring member 54, which curves outwardly, with the resin material, the seal portion 56 slightly protrudes from the ejection surface 55a.

The seal portion 56 can be made of a resin material, including without limitation an abrasion-resistant and insulating synthetic resin material. For example, an epoxy resin or an acrylic resin among ultraviolet curing resins and heat-curable resins or glass can be used for the seal portion 56.

The assembling method of the ejection unit 32 is described next. The frame 57 is mounted on the nozzle sheet 55 so that a plurality of the nozzles 55b arranged substantially in a line for each color is opposed to the opening 57a for the corresponding color. The nozzle sheet 55 is then bonded to the frame 57 with an adhesive agent. Thereafter, the first substrate 52, the second substrate 53 connected to the first substrate 52 by the external wiring member 54, and the passage plate 51 are inserted into the opening 57a of the frame 57. The film 58 is disposed between the first substrate 52 and the nozzle sheet 55. The passage plate 51 is secured to the frame 57. The first substrate 52 is then secured to the nozzle sheet 55 by heat-curing the film 58. Subsequently, a resin material is injected from the window portion 55c to seal the external wiring member 54, which was exposed to the outside through the window portion 55c. The resin material is then cured to form the seal portion 56.

In the ejection unit 32 having such a structure, to assemble the first substrate 52 and the second substrate 53 on the nozzle sheet 55, the window portion 55c of the nozzle sheet 55 is filled with a resin material and the seal portion 56 is formed. Additionally, to completely cover the end 54a of the external wiring member 54, which is curved outwardly, with the resin material, the seal portion 56 slightly protrudes from the ejection surface 55a. For example, the seal portion 56 protrudes from the ejection surface 55a by a height of about 300 μm. A cleaning roller 83 for removing the extra ink i deposited to the ejection surface 55a is brought into contact with the seal portion 56, and therefore, a pressure is applied to the connection point between the end 54a of the external wiring member 54 and the connection portion of the wire on the first substrate 52. The cleaning roller 83 is described later.

To solve this problem, the seal portion 56 is formed from a resin material having a Shore D hardness (based on Japanese Industrial Standards (JIS) K-7215) of more than or equal to 55, preferably more than or equal to 60, and more preferably more than or equal to 70. For example, the resin material of the seal portion 56 having a Shore D hardness of more than or equal to 55 prevents the seal portion 56 from deforming even when the cleaning roller 83a applies a pressure of more than or equal to 100 g/cm² to the seal portion 56, which is a minimum pressure to remove ink on the ejection surface 55a. Thus, the pressure applied to the external wiring member 54 inside the seal portion 56 can be prevented. Consequently, the end 54a of the external wiring member 54 is not bent by the pressure, and the connection portion between the external wiring member 54 and the first substrate 52 is sufficiently protected so that the external wiring member 54 does not break or does not come apart from the first substrate 52. In the ejection unit 32, the reliability of the connection between the external wiring member 54 and the first substrate 52 increases. The electrical connection between the external wiring member 54 and the first substrate 52 can be maintained even when a high pressure is applied to the ejection surface 55a, and therefore, the heat element 71 is prevented from being inoperable.

Furthermore, the seal portion 56 can protect the external wiring member 54, the first substrate 52, and the external wiring member 54 from the ink i ejected from the nozzle 55b. The seal portion 56 formed from a resin material having a Shore D hardness of more than or equal to 80 after hardening may have a coefficient of linear expansion significantly different from a material of the first substrate 52 and a material of the nozzle sheet 55, which is described below. This may result in the seal portion 56 coming apart when the resin material is cured. Accordingly, it is desirable that the hardness of the cured seal portion 56 is less than a Shore D hardness of 80.

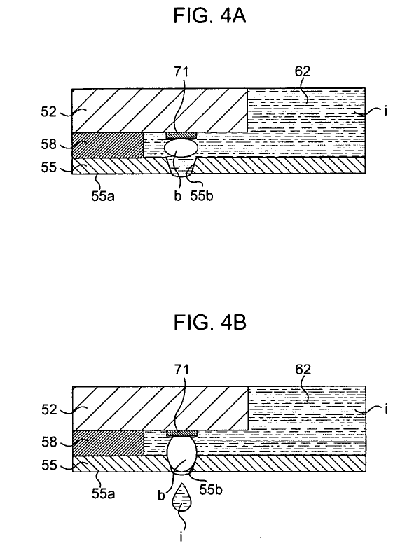

In the ejection unit 32 having such a structure, the drive of the heat element 71 is controlled by a driving circuit. For example, the driving circuit supplies the selected heat element 71 with a pulse current for 1 to 3 microseconds to rapidly heat the heat element 71. In the ejection unit 32, as shown in FIG. 4A, a bubble b is generated in the ink i contained in the ink liquid chamber 62, which is in contact with the heat element 71. As shown in FIG. 4B, the bubble b expands to increase the pressure in the ink liquid chamber 62, so that the expelled ink i is ejected from the nozzle 55b as a liquid droplet. After the liquid droplet of the ink i is ejected, the ink i is supplied to the ink liquid chamber 62 via the flow channel 61. Thus, the ink liquid chamber 62 returns to the state before the ejection.

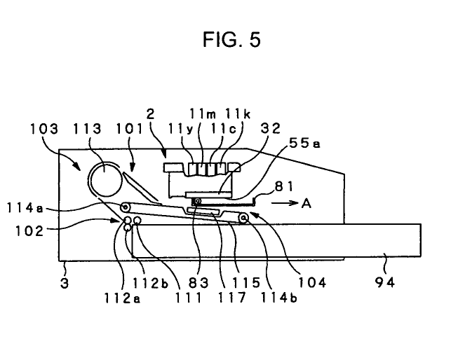

As shown in FIGS. 2 and 5, the cartridge body 12 includes an ejection-surface protective cover 81 for protecting the ejection surface 55a by removing the extra ink i deposited on the ejection surface 55a which ejects the ink i in the ejection unit 32.

The ejection-surface protective cover 81 includes a pair of guide blades 82 and the cleaning roller 83. The guide blades 82 protrude upwardly from the short sides of the ejection-surface protective cover 81 and the top portion of each guide blade 82 is outwardly bent substantially at 90 degrees. The cleaning roller 83 absorbs the ink i deposited on the ejection surface 55a. The guide blades 82 fit a pair of guide grooves 12a formed in the cartridge body 12 adjacent to the ejection surface 55a so that the guide blades 82 hold the ejection-surface protective cover 81 in sliding contact with the ejection surface 55a and substantially in parallel to each other. The ejection-surface protective cover 81 is moved by a cover open/close mechanism (not shown) of the printer body 3 in the direction shown by arrow A in FIGS. 2 and 5. The ejection-surface protective cover 81 is removed from the bottom of the cartridge body 12 before the print operation and fits the bottom of the cartridge body 12 after the print operation.

As shown in FIG. 2, the cleaning roller 83 has a cylindrical rod shape. The cleaning roller 83 is formed from an absorber foam material made of, for example, a resin. The cleaning roller 83 has a hardness of 35. Before the print operation in which the ink i is ejected, the ejection-surface protective cover 81 is removed from the bottom of the cartridge body 12 while being in sliding contact with the ejection surface 55a and translating on the ejection surface 55a in the direction shown by arrow A in FIG. 5. At that time, the ejection-surface protective cover 81 wipes out or absorbs the extra ink i deposited on the ejection surface 55a so as to clean the ejection surface 55a. After the print operation, when the ejection-surface protective cover 81 fits the bottom of the cartridge body 12, the cleaning roller 83 is brought into sliding contact with the ejection surface 55a and translates substantially parallel to the ejection surface 55a in the direction opposite to that shown by arrow A in FIG. 5. Thus, the cleaning roller 83 cleans the ejection surface 55a.

When the cleaning roller 83 cleans the ejection surface 55a, the cleaning roller 83 pushes against the seal portion 56, which protrudes from the ejection surface 55a towards the direction of ink ejection. In this embodiment, during the cleaning operation, a pressure of about 200 g/cm² is applied to the ejection surface 55a from the cleaning roller 83. Accordingly, when the ejection surface 55a is cleaned, a pressure of about 200 g/cm² is also applied to the seal portion 56. However, since the seal portion 56 has a Shore D hardness of more than or equal to 55, the pressure from the cleaning roller 83 is not transferred to the external wiring member 54 contained in the seal portion 56. That is, by sealing the external wiring member 54 with the seal portion 56, the external wiring member 54 does not swing or bend in accordance with the motion of the cleaning roller 83. Thus, the external wiring member 54 is prevented from coming apart from the first substrate 52.

The printer body 3 to which the head cartridge 2 having such a structure is mounted is described below.

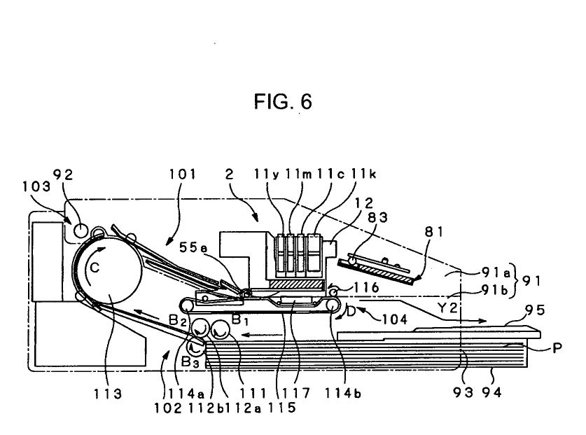

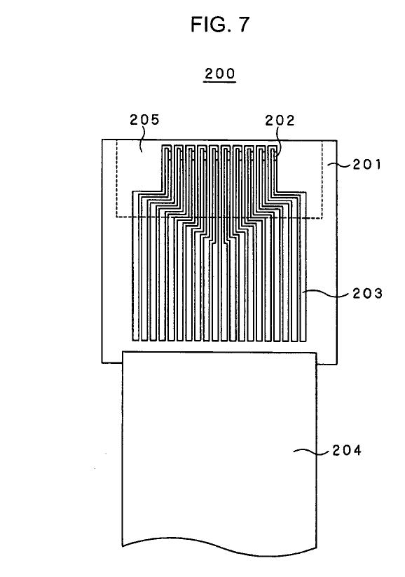

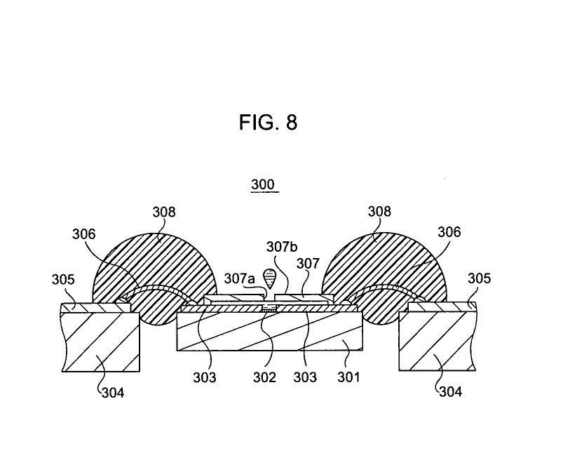

As shown in FIGS. 1 and 6, the printer body 3 is assembled into a housing 91 including an upper casing 91a and a lower casing 91b in order to prevent dust and dirt from entering the inside.

In the printer body 3, at the front side of the housing 91, a pair of supporting shafts 92 provided to both side panels of the upper casing 91a is pivotally supported by the frame 57 (not shown) in the lower casing 91b so that the upper casing 91a is openable with respect to the lower casing 91b.

As shown in FIG. 1, a paper feed and output port 93 for feeding and outputting the recording paper sheet P is formed on the front panel of the housing 91. By mounting a container tray 94 that stores the recording paper sheet P to the paper feed and output port 93, paper can be fed to the printer body 3. The recording paper sheet P is output onto a cover tray 95, which covers the front side of the opening of the container tray 94, via the paper feed and output port 93.

As shown in FIG. 1, a head mounting unit 96 to which the head cartridge 2 is mounted is formed on the upper casing 91a. When the head cartridge 2 is mounted to the head mounting unit 96, the ejection surface 55a of the head cartridge 2 is located at the printing position in the lower casing 91b, which is described later. A cover 91c is openably attached to the head mounting unit 96. When the cover 91c is closed to cover the head mounting unit 96, the cover 91c forms a continuous top surface along with the upper casing 91a. In the front area of the top surface of the upper casing 91a, operation buttons 97 for controlling a variety of operations and a display panel 98 for displaying, for example, a printing status are arranged.

Additionally, as shown in FIGS. 1 and 2, on the top surface of the upper casing 91a, a head cartridge holding mechanism 99 is formed to removably hold the head cartridge 2 in the head mounting unit 96 when the head cartridge 2 is mounted to the head mounting unit 96. By latching a knob 99a formed on the head cartridge 2 to a biasing member, such as a spring, in a latch hole 99b formed at the periphery of the upper casing 91a, the head cartridge holding mechanism 99 can determine the position of the head cartridge 2 with respect to the upper casing 91a and can securely hold the head cartridge 2. Thus, the ejection surface 55a of the cartridge body 12 faces a main surface of the recording paper sheet P delivered to the printing position by a transport belt 115, which is described later, while being parallel to each other with a predetermined gap therebetween.

As shown in FIG. 6, the lower casing 91b contains a paper feed and output mechanism 101, which feeds the recording paper sheet P to the head cartridge 2 and externally outputs the recording paper sheet P printed by the head cartridge 2. More specifically, the paper feed and output mechanism 101 includes a paper feed unit 102 for feeding the recording paper sheet P from the container tray 94, a transport unit 103 for transporting the recording paper sheet P fed from the paper feed unit 102 to the recording position, and a paper output unit 104 for ejecting the recording paper sheet P transported by the transport unit 103. These units are assembled into a frame (not shown) in the lower casing 91b.

The paper feed unit 102 serves as paper feed means for feeding the recording paper sheet P from the container tray 94 to the transport unit 103. The paper feed unit 102 includes a feed roller 111 for feeding the recording paper sheet P in the container tray 94 to the transport unit 103 and a pair of separation rollers 112a and 112b for delivering the single recording paper sheet P fed from the feed roller 111 to the transport unit 103 at a time. These rollers are driven by a driving mechanism (not shown) in the lower casing 91b to cooperatively rotate in the directions shown by arrows B1, B2, and B3 in FIG. 6.

The transport unit 103 serves as transport means for transporting the recording paper sheet P from the paper feed unit 102 to the paper output unit 104. The transport unit 103 includes an inversion roller 113 and a transport belt 115. The inversion roller 113 rotates in the direction shown by arrow C in FIG. 6 to reverse the feed direction of the recording paper sheet P from the back to the front. The transport belt 115 is an endless belt entrained about a driving pulley 114a and a driven pulley 114b and transports the recording paper sheet P whose feed direction is reversed by the inversion roller 113 to the printing position. At print time, the transport belt 115 is moved to a position opposed to the ejection surface 55a by a belt elevation mechanism (not shown). At non-print time, the transport belt 115 is located at a position under the position opposed to the ejection surface 55a.

As shown in FIG. 6, the paper output unit 104 serves as paper output means for ejecting the recording paper sheet P transported by the transport unit 103. The paper output unit 104 includes a spur 116 facing the driven pulley 114b with the transport belt 115 therebetween. The recording paper sheet P is output to the paper feed and output port 93 through a nip defined by the spur 116 and the transport belt 115.

The printing apparatus 1 having such a structure includes a control unit (not shown) for performing overall control of the printing operation by controlling the above-described cover open/close mechanism for the cover of the printer body 3, the paper feed and output mechanism 101, the belt elevation mechanism (not shown) for elevating the transport belt 115, and the ejection unit 32 for ejecting the ink i. This control unit includes a read only memory (ROM) for storing a control program that performs overall control of the printing apparatus 1 and a random access memory for temporarily storing the control program read out of the ROM. By the control unit controlling the cover open/close mechanism, the paper feed and output mechanism 101, the belt elevation mechanism, and the ejection unit 32, the printing apparatus 1 performs a print operation as follows:

To start the printing operation of the printing apparatus 1, a user operates the operation buttons 97 on the printer body 3 to instruct the control unit to start the printing operation. The control unit controls the drive of the cover open/close mechanism and the belt elevation mechanism so that the printing apparatus 1 enters a print ready mode. More specifically, the belt elevation mechanism moves the transport belt 115 to the position opposed to the ejection surface 55a. As shown in FIG. 5, the cover open/close mechanism moves the ejection-surface protective cover 81 towards the front of the printing apparatus 1. Thus, the ejection surface 55a of the head cartridge 2 is exposed.

As shown in FIG. 5, when the ejection-surface protective cover 81 moves towards the front of the printing apparatus 1, the cleaning roller 83 attached to the ejection-surface protective cover 81 is brought into sliding contact with the ejection surface 55a to absorb extra ink i deposited on the ejection surface 55a before ejecting the ink i. Accordingly, the ejection surface 55a of the head cartridge 2 is cleaned. At that time, since the cleaning roller 83 is in contact with the ejection surface 55a of the ejection unit 32, a pressure is applied from the cleaning roller 83 to the seal portion 56 which protrudes from the ejection surface 55a in the direction of ink ejection in order to protect the external wiring member 54. Even when the pressure is applied from the cleaning roller 83 to the seal portion 56, the transfer of the pressure to the external wiring member 54 inside the seal portion 56 is prevented since the cured seal portion 56 has a Shore D hardness of more than or equal to 55. Consequently, since the pressure is not transferred to the external wiring member 54 when the cleaning roller 83 cleans the ejection surface 55a, the external wiring member 54 does not swing or bend in accordance with the motion of the cleaning roller 83. Thus, the external wiring member 54 is prevented from breaking or coming apart from the first substrate 52. As a result, the electrical connection between the first substrate 52 and the second substrate 53 can be maintained.

Subsequently, the paper feed and output mechanism 101 urges the outer periphery of the feed roller 111, which rotates in the direction shown by arrow B1 in FIG. 6, against the recording paper sheet P contained in the container tray 94 to feed the recording paper sheet P from the container tray 94. The fed recording paper sheet P passes through the nip defined by the separation rollers 112a and 112b, which respectively rotate in the directions shown by arrow B2 and B3 in FIG. 6, and is delivered towards the back side of the printing apparatus 1.

The transport unit 103 delivers the recording paper sheet P fed towards the back side to the front side of the printing apparatus 1 by using the inversion roller 113 rotating in the direction shown by arrow C in FIG. 6. The paper output unit 104 then transports the recording paper sheet P delivered towards the front side to the printing position by using the transport belt 115 rotating in the direction shown by arrow D in FIG. 6. At the printing position, the recording paper sheet P is raised by a platen plate 117 disposed at a position opposed to the ejection surface 55a. Thus, the recording paper sheet P faces the ejection surface 55a of the head cartridge 2.

Thereafter, in the head cartridge 2, the control circuit on the second substrate 53 controls the drive of the heat element 71. The selected heat element 71 heats the ink i to eject the ink i onto the recording paper sheet P delivered to the printing position. In the head cartridge 2, since the connection point between the first substrate 52 and the external wiring member 54 which connects the first substrate 52 to the second substrate 53 is protected by the seal portion 56, the electrical connection between the first substrate 52 and the second substrate 53 is in good conditions. Accordingly, the ink i is appropriately ejected in response to a control signal. Thus, the head cartridge 2 can record characters and images corresponding to character data and image data input to the printing apparatus 1.

The paper feed and output mechanism 101 delivers the printed recording paper sheet P to the front side of the printing apparatus 1 through a nip defined by the transport belt 115 and the spur 116 by driving the transport belt 115. The recording paper sheet P is output from the paper feed and output port 93 onto the cover tray 95. The belt elevation mechanism lowers the transport belt 115 from the transport position to the standby position after printing.

The cover open/close mechanism then moves the ejection-surface protective cover 81 towards the back of the printing apparatus 1. The ejection-surface protective cover 81 is located at a position where the ejection-surface protective cover 81 protects the ejection surface 55a. At the same time, while the ejection-surface protective cover 81 is sliding on the ejection surface 55a towards the back of the printing apparatus 1, the cleaning roller 83 cleans the ejection surface 55a. Accordingly, a pressure is applied from the cleaning roller 83 to the seal portion 56. However, the transfer of the pressure to the external wiring member 54 inside the seal portion 56 is prevented since the cured seal portion 56 has a Shore D hardness of more than or equal to 55. Consequently, the external wiring member 54 does not swing or bend in accordance with the motion of the cleaning roller 83. Thus, the external wiring member 54 is prevented from breaking or coming apart from the first substrate 52. As a result, an electrical connection between the first substrate 52 and the second substrate 53 can be maintained in good conditions. Thus, the ejection-surface protective cover 81 closes while cleaning the ejection surface 55a of the head cartridge 2 by using the cleaning roller 83.

Thus, the head cartridge 2 returns to an original mode before printing. In this printing apparatus 1, since the ejection-surface protective cover 81 covers the ejection surface 55a of the head cartridge 2, the ink i is prevented from drying even when the head cartridge 2 is removed from the head mounting unit 96 of the printer body 3. This is the end of the printing operation.

As described above, in the printing apparatus 1, the cured seal portion 56, which seals the external wiring member 54 for connecting the first substrate 52 having the heat element 71 to the second substrate 53 having the control circuit controlling the heat element 71 and the connection part of the external wiring member 54, has a Shore D hardness of more than or equal to 55, preferably more than or equal to 60, and more preferably more than or equal to 70. Consequently, even when a pressure is applied from the cleaning roller 83 to the seal portion 56, the transfer of the pressure to the external wiring member 54 inside the seal portion 56 is prevented. In the printing apparatus 1, since the external wiring member 54 and its connection portion are sufficiently protected by the seal portion 56, the external wiring member 54 is prevented from breaking or coming apart from the first substrate 52. As a result, the reliability of the electrical connection between the first substrate 52 and the second substrate 53 can increase. Since the electrical connection between the first substrate 52 and the second substrate 53 is maintained, the heat element 71 can be appropriately controlled.

In the foregoing description, the head cartridge 2 is removable with respect to the cartridge body 12. However, an embodiment of the present invention is not limited to this structure. Alternatively, since the head cartridge 2 itself is considered to be a consumable supply and is removable with respect to the printer body 3, the ink tank 11 can be integrated into the cartridge body 12.

Additionally, in the foregoing description, the present invention is applied to a printing apparatus. However, the present invention is not limited to being applied to a printing apparatus. The present invention can be widely applied to other liquid ejection apparatuses that eject a liquid droplet. For example, the present invention can be applied to a facsimile, a copier, a DNA-chip ejection apparatus (refer to, for example, Japanese Unexamined Patent Application Publication No. 2002-253200), and a liquid ejection apparatus for ejecting liquid containing conductive particles to form a wiring pattern on a printed circuit board.

In the foregoing description, the ejection unit 32, which ejects the ink i by a single heat element 71 for heating the ink i, is described. However, the present invention is not limited to such a structure. For example, the present invention can be applied to a liquid ejection apparatus including a plurality of pressure generating elements and ejection means capable of controlling the ejection direction by supplying different energy to each pressure generating element or supplying the energy to each pressure generating element at a different timing.

Furthermore, in the foregoing description, the electrothermal transducer method is employed in which a single heat element 71 heats the ink i to eject the ink i from the nozzle 55b. However, the present invention is not limited to such a method. For example, the present invention can be applied to an electromechanical transducer method in which an electromechanical transducer, such as a piezoelectric element, electromechanically ejects the ink i from the nozzle sheet 55.

Still furthermore, in the foregoing description, a line printing apparatus is described. However, the present invention is not limited to a printing apparatus of such a type. For example, the present invention can be applied to a serial liquid ejection apparatus in which, for example, an ink head moves in a direction substantially orthogonal to the feed direction of the recording paper sheet P.

### EXAMPLES

Examples 1 through 3, in which cured seal portions having different hardness according to the embodiment of the present invention were fabricated, and a comparative example 1 are described below.

### Example 1

In example 1, a liquid ejection head was fabricated as follows: first, the frame 57 was mounted on the nozzle sheet 55 such that a plurality of the nozzles 55b arranged substantially in a straight line for each color faced the opening 57a of the frame 57 for the corresponding color. The nozzle sheet 55 was bonded to the frame 57 by an adhesive agent. Then, the first substrate 52 including twenty heat elements 71 in the opening 57a of the frame 57 was connected to the second substrate 53 including a control circuit for controlling these heat elements 71 via twenty external wiring members 54. The connected first substrate 52 and the second substrate 53, and the passage plate 51 were inserted into the frame 57 with the film 58 therebetween. The passage plate 51 was secured to the frame 57. The first substrate 52 was secured to the nozzle sheet 55 by heat-curing the film 58. Thereafter, in order to seal the external wiring member 54 which was exposed to the outside through the window portion 55c of the nozzle sheet 55, the ultraviolet-curing resin material (acrylic ultraviolet-curing resin: ThreeBond 3006C available from Three Bond Co., Ltd.,) having a Shore D hardness of 55 was injected from the window portion 55c. The resin material was cured to form the seal portion 56. Thus, the liquid ejection head was fabricated.

### Example 2

In example 2, the liquid ejection head same as that of example 1 was fabricated except that the ultraviolet-curing resin material (acrylic ultraviolet-curing resin: ThreeBond 3052D available from Three Bond Co., Ltd.,) having a Shore D hardness of 60 was used for the seal portion 56.

### Example 3

In example 3, the liquid ejection head same as that of example 1 was fabricated except that the ultraviolet-curing resin material (acrylic ultraviolet-curing resin: ThreeBond 3003 available from Three Bond Co., Ltd.,) having a Shore D hardness of 70 was used for the seal portion 56.

### Comparative Example 1

In comparative example 1, the liquid ejection head same as that of example 1 was fabricated except that the ultraviolet-curing resin material (acrylic ultraviolet-curing resin: ThreeBond 3006 available from Three Bond Co., Ltd.,) having a Shore D hardness of 20 was used for the seal portion 56.

As test 1, the cleaning roller 83 was brought into contact with the liquid ejection heads fabricated in examples 1 through 3, and comparative example 1 100,000 times while applying a pressure of 100 g/cm² to the ejection surfaces 55a of the nozzle sheets 55 of the liquid ejection heads. The break of the external wiring member 54 was then checked to evaluate the liquid ejection heads.

As test 2, the cleaning roller 83 was brought into contact with the liquid ejection heads fabricated in examples 1 through 3, and comparative example 1 1,000,000 times while applying a pressure of 100 g/cm² to the ejection surfaces 55a of the nozzle sheets 55 of the liquid ejection heads. The break of the external wiring member 54 was then checked to evaluate the liquid ejection heads, as in Test 1.

Additionally, as test 3, the cleaning roller 83 was brought into contact with the liquid ejection heads fabricated in examples 1 through 3, and comparative example 1 1,000,000 times while applying a pressure of 200 g/cm² to the ejection surfaces 55a of the nozzle sheets 55 of the liquid ejection heads. The break of the external wiring member 54 was then checked to evaluate the liquid ejection heads, as in test 1. Table 1 shows the evaluation results of the liquid ejection heads in examples 1 through 3, and comparative example 1.

TABLE 1

| | Test 1 | Test 2 | Test 3 |
|---|---|---|---|
| Example 1 | good | fair | fair |
| Example 2 | good | good | fair |
| Example 3 | good | good | good |
| Comparative | poor | poor | poor |
| example 1 | | | |

The break of the external wiring member 54 was evaluated by viewing the change in shape of the seal portion 56 and the break itself of the external wiring member 54 first. A normal operation was then evaluated by ejecting ink. In Table 1, if the seal portion 56 does not change in shape and the external wiring member 54 does not break and if the seal portion 56 works properly, “good” is given. If, although the shape of the seal portion 56 is different from that before applying pressure, the external wiring member 54 does not break and if the seal portion 56 works properly, “fair” is given. In contrast, if the shape of the seal portion 56 is different from that before applying pressure and the external wiring member 54 breaks and if the seal portion 56 does not work properly, “poor” is given.

As can be seen from Table 1, in test 1, the liquid ejection head in comparative example 1 using an ultraviolet-curing resin having a Shore D hardness of 20 cannot maintain the shape of the seal portion 56, has the external wiring member 54 broken, and does not work properly, compared with the liquid ejection heads in examples 1 through 3 using an ultraviolet-curing resin having a Shore D hardness of more than or equal to 55. In comparative example 1, since an ultraviolet-curing resin having a Shore D hardness of 20 is used, the hardness of the cured seal portion 56 is low. When the cleaning roller is brought into contact with the seal portion 56 100,000 times while applying a pressure of 100 g/cm², the seal portion 56 deforms and the pressure from the cleaning roller 83 is transferred to the external wiring member 54 inside the seal portion 56. Therefore, in comparative example 1, when the cleaning roller 83 is brought into contact with the seal portion 56, the external wiring member 54 swings or bends in accordance with the motion of the cleaning roller 83. As a result, the external wiring member 54 comes apart from the first substrate 52 or breaks, and therefore, the electrical connection between the first substrate 52 and the second substrate 53 cannot be maintained. Thus, ink is not properly ejected and the liquid ejection head does not work properly.

In contrast, in examples 1 through 3, the seal portion 56 does not change in shape, the external wiring member 54 does not break, and the ink is properly ejected. In examples 1 through 3, since an ultraviolet-curing resin having a Shore D hardness of more than or equal to 55 is used, the hardness of the cured seal portion 56 is high. Even when the cleaning roller is brought into contact with the seal portion 56 100,000 times while applying a pressure of 100 g/cm², the seal portion 56 does not deform and the pressure from the cleaning roller 83 is not transferred to the external wiring member 54 inside the seal portion 56. Therefore, the external wiring member 54 does not come apart from the first substrate 52, and therefore, the electrical connection between the first substrate 52 and the second substrate 53 can be maintained. Thus, the ink is properly ejected.

As in test 1, in test 2 of comparative example 1, since the hardness of the cured seal portion 56 is low, the shape of the seal portion 56 cannot be maintained. The external wiring member 54 breaks. The liquid ejection head does not work properly. In contrast, in test 2 of example 1, since an ultraviolet-curing resin having a Shore D hardness of 55 is used, the pressure from the cleaning roller 83 is not transferred to the external wiring member 54 inside the seal portion 56 although the seal portion 56 deforms when the cleaning roller is brought into contact with the seal portion 56 1,000,000 times. The electrical connection between the first substrate 52 and the second substrate 53 can be maintained. By using an ultraviolet-curing resin having a Shore D hardness of 60 in example 2 and by using an ultraviolet-curing resin having a Shore D hardness of 70 in example 3, the hardness of the cured seal portion 56 is high. Therefore, even when the cleaning roller 83 is brought into contact with the seal portion 56 1,000,000 times while applying a pressure of 100 g/cm², the seal portion 56 does not change in shape. The external wiring member 54 does not break, and therefore, the electrical connection between the first substrate 52 and the second substrate 53 can be maintained. The ink is properly ejected and the liquid ejection head works properly.

In test 3 of comparative example 1, as in tests 1 and 2, since the hardness of the cured seal portion 56 is low, the shape of the seal portion 56 cannot be maintained. The external wiring member 54 breaks and the liquid ejection head does not work properly. In contrast, in examples 1 and 2, when the cleaning roller is brought into contact with the seal portion 56 1,000,000 times while applying a pressure of 200 g/cm², the seal portion 56 changes in shape. However, the pressure is not transferred to the external wiring member 54 inside the seal portion 56, and therefore, the electrical connection between the first substrate 52 and the second substrate 53 can be maintained. In example 3, since an ultraviolet-curing resin having a Shore D hardness of 70 is used, the seal portion 56 does not change in shape when the cleaning roller is brought into contact with the seal portion 56 1,000,000 times while applying a pressure of 200 g/cm². The external wiring member 54 does not break. The electrical connection between the first substrate 52 and the second substrate 53 can be maintained. The ink is ejected properly and the liquid ejection head works properly. Thus, by using an ultraviolet-curing resin having a Shore D hardness of more than and equal to 70 for the seal portion 56, the seal portion 56 can resist a high pressure with sufficient durability and can sufficiently protect the external wiring member 54.

The above-described result indicates that, by using an ultraviolet-curing resin having a Shore D hardness of more than and equal to 55 for a seal portion for protecting an external wiring member for connecting a first substrate to a second substrate, the electrical connection between the first substrate and the second substrate can be reliably maintained. Accordingly, heat from a heating element can be properly controlled and a predetermined image can be recorded.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid ejection head mounted in a liquid ejection apparatus for ejecting liquid, comprising:
a first substrate including a pressure generating element for applying pressure to the liquid;
a second substrate including a control circuit for controlling the drive of the pressure generating element;
an external wiring member for electrically connecting the first substrate to the second substrate; and
a nozzle sheet having a nozzle for ejecting the liquid and a window portion through which a connection portion between the external wiring member and the first substrate is exposed to the outside;
wherein the window portion is sealed with a resin material and a seal portion formed from the resin material is cured so as to have a Shore D hardness of more than or equal to 55.

2. The liquid ejection head according to claim 1, wherein the seal portion has a Shore D hardness of more than or equal to 60.

3. The liquid ejection head according to claim 1, wherein the seal portion has a Shore D hardness of more than or equal to 70.

4. The liquid ejection head according to claim 1, wherein the resin material is an ultraviolet-curing resin.

5. The liquid ejection head according to claim 1, wherein the pressure generating element is a heat element.

6. The liquid ejection head according to claim 1, wherein the nozzle sheet is disposed such that the nozzle faces the pressure generating element.

7. A liquid ejection apparatus for performing a recording operation by ejecting liquid onto an object, comprising:
an apparatus body; and
a liquid ejection head mounted in the apparatus body, the liquid ejection head including a first substrate including a pressure generating element for applying pressure to the liquid, a second substrate including a control circuit for controlling the drive of the pressure generating element, an external wiring member for electrically connecting the first substrate to the second substrate, and a nozzle sheet having a nozzle for ejecting the liquid and a window portion through which a connection portion between the external wiring member and the first substrate is exposed to the outside;
wherein the window portion is sealed with a resin material and a seal portion formed from the resin material is cured so as to have a Shore D hardness of more than or equal to 55.

8. The liquid ejection apparatus according to claim 7, wherein the seal portion has a Shore D hardness of more than or equal to 60.

9. The liquid ejection apparatus according to claim 7, wherein the seal portion has a Shore D hardness of more than or equal to 70.

10. The liquid ejection apparatus according to claim 7, wherein the resin material is an ultraviolet-curing resin.

11. The liquid ejection apparatus according to claim 7, wherein the pressure generating element is a heat element.

12. The liquid ejection apparatus according to claim 7, wherein the nozzle sheet is disposed such that the nozzle faces the pressure generating element.
